(19) United States
(12) Patent Application Publication
(10) Pub. No.: US 2002/0152089 A1
(43) Pub. Date: Oct. 17, 2002

(54) Customer convenience center

(76) Inventor: Vasil C. Litchin, San Marcos, CA (US)

Correspondence Address: PILLSBURY WINTHROP LLP, INTELLECTUAL PROPERTY DEPARTMENT, 1600 TYSONS PROPERTY DEPARTMENT, MCLEAN, VA, 22102, US

(21) Appl. No.: 09/837,538

(22) Filed: Apr. 17, 2001

(51) Int. Cl. G06F 17/60

(52) U.S. Cl. 705/1

(57) ABSTRACT

A system providing more rapid service to customers requiring department of motor vehicles (DMV) processing. The system includes a plurality of customer work terminals connected through a network server to a database, and connected to an attendant terminal that is connected to a printer. The server is configured with a site providing a limited set of choices on a monitor screen of each work terminal. In response to a customer's selection, the site prompts the customer to provide the data required for the selected transaction, such as an automobile registration or a driver's license renewal. The server checks customer identification data as required with corresponding data in the state database. If the entered data corresponds as required with the state database, the server prepares data for printing the required certificate.

### FIELD OF THE INVENTION

The present invention relates generally to customer transactions at state department of motor vehicle centers and their agent's offices, and more particularly to a system wherein center transactions are expedited through use of a plurality of individual customer convenience terminals supervised by a single attendant, wherein each customer enters the required data and in response the system automatically prepares the required DMV documents, which are then dispensed upon collection of the required fee.

### DESCRIPTION OF THE PRIOR ART

Traditionally, transactions at a state department of motor vehicles involves a customer securing a form from an attendant, and then manually filling out the form at a workbench. Upon completion of the form, the customer stands in what is often a long line in order to present the form to a DMV clerk, who checks the form for completeness, enters the required data into the DMV computer system, collects the fees and issues a receipt and/or document. The actual DMV document, such as a driver's license, will often require further data entry by DMV personnel. This procedure may take a number of days, and when it is complete, the certificate is mailed to the customer.

In order to minimize long lines of customers, some DMV departments have implemented an appointment system. Another attempt to expedite the process through automatic dispensing of forms is disclosed in U.S. Pat. No. 5,349,534 by Rousself et. al. A system is designed for use in dispensing automobile registrations and drivers license extensions, wherein one or two stickers are formed of a specialized reflective material that is applied to a blank paper stock, after which all the necessary printing and identification numbers are printed thereon. The paper stock is provided on a roll, and after the printing is complete, a cutting apparatus is activated to cut off a predetermined length, including the printed material. The newly printed stickers are secured to the paper stock with a release adhesive, and can be removed for customer placement on a license plate. Although the system is noted as being either attended or unattended by a government employee, the system is fully automatic and configured to be independently operated by customers.

The problem of long lines and labor-intensive government offices is also addressed in U.S. Pat. No. 4,970,655 by Winn et. al. An unattended machine/system for collecting fees and dispensing receipts is disclosed. The system is accessible to the consumer 24 hours a day and seven days a week, eliminating lengthy waits in expensive manned offices and the shortcomings of mail-in services.

Although the above-described systems appear at first glance to be a highly attractive alternative to the present DMV offices, they have not been implemented so as to replace the present systems. The reasons for this include anticipated operator problems and fraud, and a reluctance to displace a large number of DMV employees. In any case, a workable/acceptable solution to the long lines and inefficiencies in the present system is still needed.

### SUMMARY

Briefly, a preferred embodiment of the present invention includes a system providing more rapid service to customers requiring department of motor vehicles (DMV) processing. The system includes a plurality of customer work terminals connected through a network server to a database, and connected to an attendant terminal that is connected to a printer. The server is configured with a site providing a limited set of choices on a monitor screen of each work terminal. In response to a customer's selection, the site prompts the customer to provide the data required for the selected transaction, such as an automobile registration or driver's license renewal. The server checks customer identification data as required with corresponding data in the state database. If the entered data corresponds as required with the state database, the server prepares data for printing the required certificate or form.

### IN THE DRAWING

FIG. 1 is a block diagram of a preferred embodiment of the present invention;

FIG. 2 is a flowchart of the processes of a preferred embodiment of the present invention;

FIG. 3 illustrates a physical layout of a customer convenience center of the present invention; and

FIG. 4 is a flowchart summarizing the procedures for renewal of an automobile registration according to the present invention.

### DETAILED DESCRIPTION OF THE PREFERRED EMBODIMENT

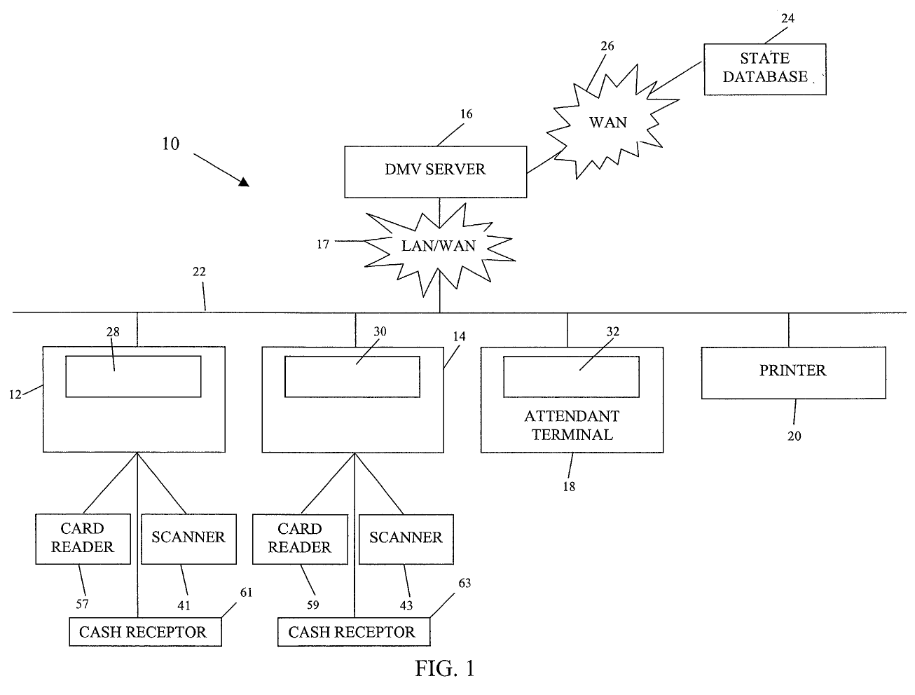

The DMV system 10 of the present invention is illustrated in FIG. 1 and includes a plurality of customer work terminals such as terminals 12 and 14, a network server 16, an attendant terminal 18 and a printer 20, with the required communications through a local area network 22. The server 16 is accessible through a network 17, which can be either a local area network (LAN), or a wide area network (WAN). The server 16 has access to a state database 24 through a wide area network (WAN) 26. The term “state database” is meant to include all the necessary functionality for communication of data from and to each DMV server 16. The server 16 can be an Internet server including a state Internet website, or the server 16 can provide a site with networks 17 and 26 as dedicated state networks. The system 10 is shown with only two customer terminals 12 and 14 and one attendant terminal 18 and printer 20, but the present invention includes any number of customer terminals. A quantity of two to eight customer terminals per each attendant terminal and printer is preferred.

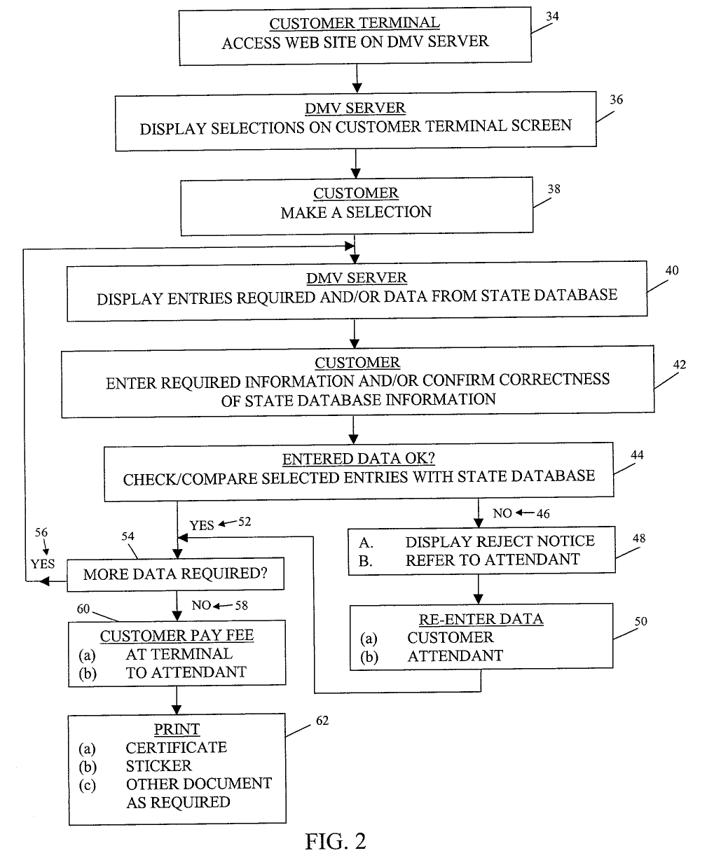

The novel programming and operation of the system 10 of the present invention will now be described in reference to the flowchart of FIG. 2 of the drawing. The DMV server 16 is pre-programmed with a DMV site providing the features described in reference to FIG. 2. According to the operation of the DMV system 10, a DMV customer accesses one of the terminals, such as terminal 12 or 14, and selects an icon to access the DMV site on server 16 (block 34). The system is preferably designed with touch screen technology to eliminate the need for a “mouse” and to make it easier for the customer to understand. The system terminal is programmed to preferably limit access to the state DMV site. Again, the network 17 can be a private network dedicated for the DMV and possibly other state functions, or the network 17 can be a public network such as the Internet. In the event the network 17 is the Internet, the site would be termed a “website” with access limited through the DMV terminals. In response, the DMV server 16 causes selections to be displayed on the customer accessed terminal monitor screen such as 28 or 30 (block 36). Alternatively, the terminals can be programmed to automatically access and maintain site contact. Reference in the following description to “accessing the site” will refer to either manual or automatic access. A preferred selection includes “automobile registration renewal.” Other selections such as “drivers license renewal” are also included in the spirit of the present invention. The customer activates/clicks on, etc. one of the selections (block 38), and the server 16 responds by causing the customer terminal monitor to display spaces/blocks for entry of the required information by the customer. For example, for driver's license renewal, the display could require the customer's driver's license number, etc. (block 40). For automobile registration renewal, the system can optionally include a bar code scanner 41, 43 for scanning a bar code from a registration renewal notice sent to the customer, or it may simply ask for the existing license plate number or some other identifier. If the selection is for a new driver's license, various spaces/blocks will be displayed for entry of the required information such as “name,” “address,” “birth date,” etc. The customer then enters the required information (block 42). For an automobile registration renewal, the customer may be asked for the “VIN number,” “license plate number,” owner's “name and address” and the name of the insurer.” The server then checks certain information items (block 44) by comparing them with information in the state database 24. For a new application for a license, this could be verification of the person's name and birth date with any state database information including, for example a social security number. If the selection is for an automobile registration renewal, the initial data entered could be the name of the owner, and the license plate number. The server can then check the license plate number and name entered to confirm that the name corresponds to the number entered as currently stored in the state database, etc. If a data item is indicated by the comparison to be incorrect 46, a notice is displayed on the terminal screen. A reference to the attendant may also be given (block 48). The data can then be re-entered or corrected by either the customer or the attendant (block 50). If the information/data entered is found to be correct 52, the process continues with block 54 which indicates the possibility of more information required. For example, if the information required at this point was simply the customer identification for automobile license renewal, more information is required 56, and the DMV server displays either blocks/blanks for entry of the data, or if the data was already in the state database, the state database information is displayed on the monitor (block 40). The customer then either confirms that the state database data is correct, or enters the correct data (block 42). The process then continues with blocks 44, and 48 and 50 as required, or if still more data is required (block 54), the processes of blocks 40-44, etc. are repeated. If all the required data is entered, i.e., if no more data is required 58, the customer can pay any required fee (block 60) either at the terminal by credit card through a card reader 57, 59 for example, or by any applicable payment method including cards, check or cash, etc., to the attendant. The system alternatively or additionally can include a cash receptor indicated as 61 and 63 in FIG. 1 for paying the fee in cash. Any required receipts and documents including registration decals, such as the “sticker” that is placed on the automobile license plate and the registration certificate are then prepared automatically (block 62) by the printer 20. The printing of the receipt and/or certificate or registration decal/sticker is preferably done in response to activation by the attendant, and alternatively in response to a customer action, such as payment of the fee through use of a credit card reader at the customer terminal. A significant advantage of the above system is that the printed matter provided can include a final, official registration certificate, and a decal or sticker if the process is for automobile registration. This avoids the process of later preparing and mailing these documents and in the case of a registration decal, the attendant does not have to manually locate, record and document a pre-printed decal. Because the system has access to the state database 24, a customer can also request a print-out of a driver's record, and this feature is included in the present invention.

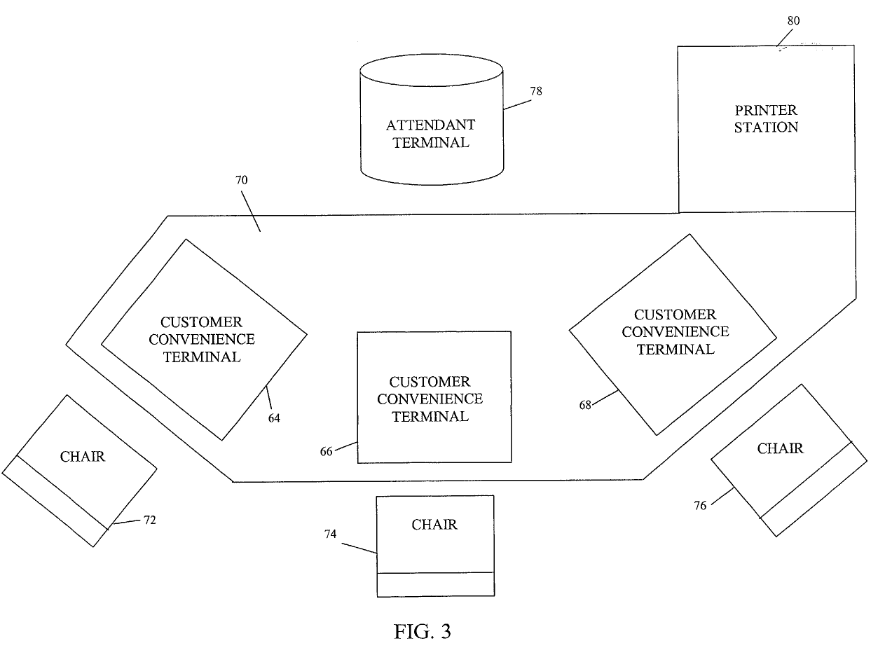

A physical layout of the customer and attendant terminals and printer of the system 10 of the present invention is illustrated in FIG. 3. Three customer terminals 64, 66 and 68 are shown on a counter 70, with optional customer chairs 72, 74 and 76. An attendant terminal 78 and printer 80 are conveniently located for servicing the customers using terminals 64, 66 and 68.

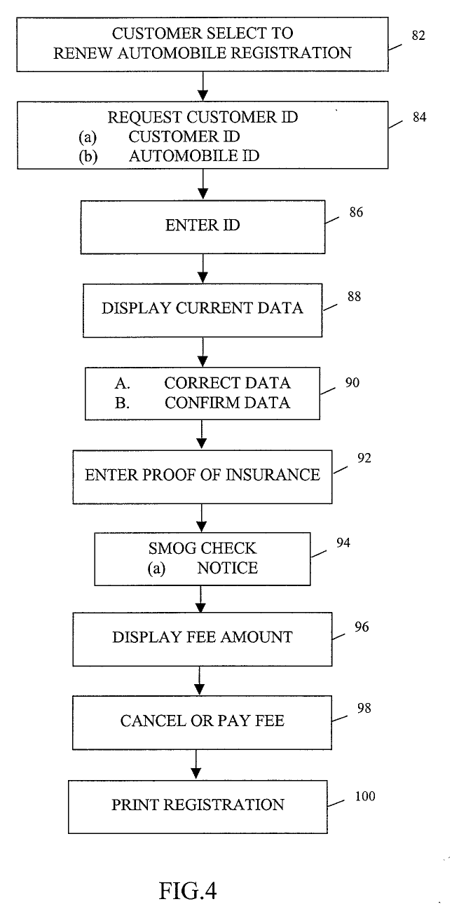

FIG. 4 is a flowchart for illustration of the process of FIG. 2 for the specific purpose of renewing an automobile registration. Typically a customer enters the DMV facility and sits or stands at a customer terminal and selects to renew auto registration. It is assumed by block 82 that the DMV site is accessed. The customer selects the auto registration renewal choice, and it is then displayed on the terminal screen. The feature of automatically accessing the DMV site and displaying the choices upon initial system turn-on is an alternate embodiment for the process of FIG. 2 and as applied to FIG. 4. The server then displays a request for identification (block 84) and the customer enters the required ID (block 86). For example, auto identification could be the license plate number, and could be entered in any of a variety of ways known to those skilled in the art. For example, the customer can type the number or enter it through a thin-wall touch screen. Alternatively, the software and hardware of the system 10 can be configured to require a VIN number, or the system can include a bar code scanner and require the reading of the bar code from a code printed on a renewal notice. As indicated in FIG. 2, the system can check the vehicle ID with data in the state database to determine if it is a valid currently registered vehicle. The customer also enters his/her personal ID, such as a social security number, etc. and the system can verify/check if the auto and personal IDs correspond. If the customer is a new owner of the vehicle, a selection for that procedure would be made initially. Assuming that the data entered is correctly entered per FIG. 2, the system displays the current data on the monitor screen (block 88). The customer then either updates/corrects the information, such as address and phone number, etc. or selects an icon to confirm the data as correct (block 90). The customer then supplies proof of insurance (block 92) by entering the underwriter's name and policy number, which can be verified by comparing with state database insurance data or by whatever method the particular state has implemented. Currently, many states do not require proof of insurance, so this is an optional/alternate element according to the present invention. The system then checks to determine if the vehicle is currently smog approved (block 94) and if not, a notice is given to “smog” the vehicle. Again, smog testing may not be required by a state for registration renewal, and therefore inclusion of this element is an alternate embodiment of the present invention. Some states require smog testing, but do not include it in the automobile registration process. If all of the above is acceptable, the system displays the fee amount for renewal (block 96). The customer then either cancels the transaction, or accepts it by paying the fee (block 98). The fee is preferably paid to the attendant and a registration is then printed, based on the entered information (block 100). As an alternate embodiment, the fee can be paid at the terminal and the registration and decal automatically printed.

An alternate embodiment of the system of FIG. 1 omits the attendant terminal, but retains the service of the attendant for assisting the customers in their operation of the customer terminals. An alternate embodiment also includes manually collecting the fees and operating the printer from each customer terminal. As explained above, the system 10 can also include a card reader 57, 59 allowing a customer to pay the fee with a credit card. An alternate embodiment also provides a cash receptor for customers who prefer to pay the required fee(s) with cash. The bar code scanners 41 and 43 as indicated in FIG. 1 are an alternate embodiment for entry of vehicle identification, for example from a bar code on a renewal notice.

The system 10 as described above requires an attendant to assist the customers. A ratio of four to six customer terminals to one attendant is preferred, although the ratio can be any number according to the present invention. The attendant is an attractive feature in allowing a human to help customers. The supervision of a plurality of customer terminals by a single attendant is a significant advantage over prior art fully automatic systems which do not provide an attendant as discussed in the description of the prior art. Unattended systems are often too intimidating for many customers. An estimated 25 million customers nationwide do not have credit cards or bank accounts. The present invention is also a significant improvement over the currently popular non-automated, fully attended DMV offices, making it possible for a single attendant to do the work of two to eight employees in the current fully attended DMV offices.

The system of the present invention is also less expensive to maintain and operate than the proposed unattended self-service kiosks, and can be expanded, reduced or moved without having to schedule several subcontractors. One reason for this is that the system 10 communicates with the state database through a state site, or through a state network. The prior art unattended kiosks are dedicated ISDN or similar lines, which are expensive to install and maintain. The software of the system 10 of the present invention limits the customer's access to the designated site or sites required for the function of the DMV system.

The system 10 of the present invention also allows different types of printers to be used, permitting more functions to be transacted on them than the existing self-service (unattended) kiosks. For example, driving records can be requested and printed on the system 10. This cannot be done on the self-service kiosks. The system 10 customer terminals can also include cash and check acceptors and other features.

The system 10 prints a final registration and decal. This is an advantage over the prior art systems that only print a receipt, or a temporary decal requiring that the permanent registration and decal be mailed to the customer.

Although the present invention has been described above in terms of a specific embodiment, it is anticipated that alterations and modifications will no doubt become apparent to those skilled in the art. It is therefore intended that the following claims be interpreted as covering all such alterations and modifications as follows in the true spirit and scope of the invention.

It is claimed that:

1. A system for providing customer service at a department of motor vehicles (DMV) office, said system comprising:
(a) a plurality of customer terminals connected to a network;
(b) a state site accessible through said network, said site including
(i) means for displaying data on a said terminal accessing said site, said data including a list of processes for selection by a customer;
(ii) means for accessing a state database for access to DMV data;
(iii) means for preparing document data in response to receiving customer data from a said customer terminal;
(c) a printer apparatus for printing a document; and
(d) an attendant for assisting in entry of said customer data and in said printing as required.

2. A system as recited in claim 1 wherein each said customer terminal is programmed to automatically access said state site.

3. A system as recited in claim 1 wherein a said process includes motor vehicle registration.

4. A system as recited in claim 1 wherein a said process includes driver's license renewal.

5. A system as recited in claim 1 wherein in response to a said selection said site displays an item required to be entered by a customer.

6. A system as recited in claim 5 wherein said item includes a customer identification.

7. A system as recited in claim 5 wherein said item includes an automobile identification.

8. A system as recited in claim 1 wherein said site further includes means for displaying a selected quantity of said motor vehicle data from said database on a selected said customer terminal.

9. A system as recited in claim 8 wherein said site includes means allowing a customer to update a particular said motor vehicle data displayed on a said customer terminal.

10. A system as recited in claim 3 wherein said document is a completed official motor vehicle registration document.

11. A system as recited in claim 4 wherein said document is a completed official driver's license renewal form.

12. A system as recited in claim 1 further comprising means for collecting a fee for a said process.

13. A method of servicing department of motor vehicles customers, said method comprising:
(a) accessing a state site from one of a plurality of terminals;
(b) first displaying a selection of procedures provided by said site on a screen of a said terminal for selection by a customer;
(c) second displaying motor vehicle department data on said screen, wherein said customer can enter customer data for preparing a document;
(d) collecting a fee;
(e) printing an official certificate for said customer in response to said entry of said customer data and said collecting a fee; and
(f) attending said plurality of terminals by a live person for assisting said customers.

14. A method as recited in claim 13 wherein a said procedure is a motor vehicle registration.

15. A system as recited in claim 1 wherein said document includes a decal.

16. A method as recited in claim 14 wherein said customer data includes updated data for said registration.

17. A system as recited in claim 3 wherein said document includes a sticker for attachment to an automobile license plate, and an automobile registration certificate.

18. A system as recited in claim 1 wherein said network improves the Internet.

19. A system as recited in claim 1 wherein said terminals are programmed to limit access to said state website.

20. A system as recited in claim 1 including means for accessing drivers record data in said database and displaying said data on a screen of a said terminal.

21. A system as recited in claim 1 wherein said site is a website accessed through an Internet connection.

22. A method as recited in claim 13 wherein said site is a website accessed through an Internet connection.
